(19) United States
(12) Patent Application Publication
(10) Pub. No.: US 2014/0214660 A1
(43) Pub. Date: Jul. 31, 2014

(54) METHOD AND RELATED DEVICE FOR ACCESSING ACCESS POINT

(71) Applicant: Huawei Device Co., Ltd., Shenzhen (CN)

(72) Inventor: Tianliang XU, Xi'an (CN)

(73) Assignee: Huawei Device Co., Ltd., Shenzhen (CN)

(21) Appl. No.: 14/143,932

(22) Filed: Dec. 30, 2013

Related U.S. Application Data
(63) Continuation of application No. PCT/CN2013/080964, filed on Aug. 7, 2013.

(30) Foreign Application Priority Data
Jan. 29, 2013 (CN) 201310034152.9

(51) Int. Cl. H04W 48/16; G06Q 30/04

(52) U.S. Cl. CPC H04W 48/16; G06Q 30/04
USPC 705/40; 370/328

(57) ABSTRACT

Embodiments of the present application disclose a method and a related device for accessing an access point. According to the embodiments, a user terminal acquires a two-dimension code, parses the two-dimension code to acquire information about the two-dimension code. A two-dimension code is automatically scanned or acquired without a need to use a keyboard to enter a password or synchronously click a WPS button, in which case the operation is convenient and simple and a size of a user terminal is reduced. In addition, a two-dimension code may be generated by an access point, in which case a password leak does not occur easily and a system is prevented from breakdown caused by an attack by an unauthorized user.

### CROSS-REFERENCE TO RELATED APPLICATIONS

This application is a continuation of International Patent Application No. PCT/CN2013/080964, filed on Aug. 7, 2013, which claims priority to Chinese Patent Application No. 201310034152.9, filed on Jan. 29, 2013, both of which are hereby incorporated by reference in their entireties.

### TECHNICAL FIELD

This application relates to the field of communications technologies, and in particular to a method and a related device for accessing an access point.

### BACKGROUND

Currently, as wireless local area network (Wireless Local Area Network, WLAN) services are being promoted by operators, access points (Access Point, AP) using the Wireless Fidelity (Wireless Fidelity, WiFi) technology are deployed in more and more regions; specifically, an AP broadcasts a service set identifier (Service Set Identifier, SSID) provided by an operator of the AP in an open manner; upon detecting the SSID, a user terminal associates with the AP identified by the SSID if the user terminal decides to access the SSID and enters a correct password to ensure access to the AP. After accessing the AP, the user terminal can implement a related network application service.

Generally speaking, the user terminal needs to be connected to a peripheral such as a keyboard to enter a password to associate with the AP; however, in situations in which a micro user terminal has no peripheral such as a keyboard, the user cannot enter an access password and therefore cannot connect to the AP. In addition, in situations in which an access password is very long or an SSID is very long, the access password or SSID may be entered incorrectly, increasing difficulty in identification and lowering the efficiency in accessing the AP. Moreover, an administrator is required to provide an access password, and the user terminal is required to enter the access password to access the AP. If there is any vulnerability in user identity authentication or there is a password leak, which may easily occur because a password is generally in a form of letters or numbers, a system breaks down due to an attack by an unauthorized user.

Currently, a user terminal may also access a WiFi AP in a manner stipulated by a standard of Wi-Fi protected setup (Wi-Fi Protected Setup, WPS), in which case the user needs to click a WPS button of the Wi-Fi AP for a long time. Within the time when a WPS button of the user terminal is clicked, if the WPS button of the Wi-Fi AP is also in a clicked state, the user terminal may access the Wi-Fi AP to conduct a related network application service. The WPS button of the user terminal and the WPS button of the Wi-Fi AP must be synchronized in order to establish a connection, where the operation is complex and impractical; in addition, a successful connection supports only a current service application, and cannot be used again once the current service is disconnected, making a connection operation more cumbersome.

### SUMMARY

Embodiments of the present application provide a method and a related device for accessing an access point, which solves a problem that a current method for accessing an access point is operationally complex and provides low security performance.

In a first aspect, an embodiment of the present application provides a method for accessing an access point, including:

acquiring, by a user terminal, a two-dimensional code;

parsing, by the user terminal, the two-dimensional code to obtain information about the two-dimensional code, where the information about the two-dimensional code includes an access password of the access point and an identifier of the access point; and

accessing, by the user terminal, the access point according to the access password of the access point and the identifier of the access point.

With reference to the first aspect, in a first possible implementation manner, the acquiring, by a user terminal, a two-dimensional code includes:

acquiring, by the user terminal in a scanning manner, the two-dimensional code.

With reference to the first possible implementation of the first aspect, in a second possible implementation manner, the acquiring, by the user terminal in a scanning manner, a two-dimensional code includes:

sending, by the user terminal, a scanning request to the access point, so that the access point generates a two-dimensional code and the access point displays the two-dimensional code on a screen; and

scanning, by the user terminal, the screen to acquire the two-dimensional code.

With reference to the first aspect, in a third possible implementation manner, the acquiring, by a user terminal, a two-dimensional code includes:

acquiring, by the user terminal, an image carrying a two-dimensional code; and

parsing, by the user terminal, the image carrying the two-dimensional code to acquire the two-dimensional code.

With reference to the third possible implementation manner of the first aspect, in a fourth possible implementation manner, the acquiring, by the user terminal, an image carrying a two-dimensional code includes:

sending, by the user terminal, a first request to the access point, so that the access point generates an image carrying a two-dimensional code, where the first request is configured to request an image carrying a two-dimensional code; and

receiving, by the user terminal, first information sent by the access point, where the first information includes the image carrying the two-dimensional code.

With reference to the fourth possible implementation manner of the first aspect, in a fifth possible implementation manner, after the sending, by the user terminal, a first request to the access point and before the receiving, by the user terminal, first information sent by the access point, the method further includes:

receiving, by the user terminal, payment request information sent by the access point, so that the user makes a payment according to the payment request information, where the payment request information includes a pricing standard and a charging mode and the first information further includes information about duration or traffic in accessing the access point.

With reference to the second possible implementation manner of the first aspect, in a sixth possible implementation manner, the scanning, by the user terminal, the screen includes:

scanning, by the user terminal by using a camera, the screen.

With reference to the first aspect, the first possible implementation manner of the first aspect, or the second possible implementation manner of the first aspect, in a seventh possible implementation manner, the information about the two-dimensional code further includes information about duration or traffic in accessing the access point.

In a second aspect, an embodiment of the present application provides a method for accessing an access point, including:

receiving a scanning request sent by a user terminal; generating a two-dimensional code; and

displaying the two-dimensional code on a screen, so that the user terminal scans the screen to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point.

With reference to the second aspect, in a first possible implementation manner, the generating a two-dimensional code includes:

generating a two-dimensional code according to the identifier of the access point, the access password of the access point, and an encryption manner.

In a third aspect, an embodiment of the present application provides a method for accessing an access point, including:

sending an image carrying a two-dimensional code to a user terminal, so that the user terminal acquires the image carrying the two-dimensional code, the user terminal parses the image carrying the two-dimensional code to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point.

With reference to the third aspect, in a first possible implementation manner, the sending an image carrying a two-dimensional code to a user terminal includes:

receiving a first request sent by the user terminal, where the first request is configured to request an image carrying a two-dimensional code;

generating the image carrying the two-dimensional code; and

sending first information to the user terminal, so that the user terminal acquires the first information, where the first information includes the image carrying the two-dimensional code.

With reference to the first possible implementation manner of the third aspect, in a second possible implementation manner, after the receiving a first request sent by the user terminal and before the sending first information to the user terminal, the method further includes:

sending payment request information to the user terminal, so that the user makes a payment according to the payment request information, where the payment request information includes a pricing standard and a charging mode and the first information further includes information about duration or traffic in accessing the access point.

With reference to the first possible implementation manner of the third aspect, in a third possible implementation manner, the generating the image carrying the two-dimensional code includes:

generating the two-dimensional code; and

encapsulating the two-dimensional code into an image.

With reference to the third possible implementation manner of the third aspect, in a fourth possible implementation manner, the generating the two-dimensional code includes:

generating the two-dimensional code according to the identifier of the access point, the access password of the access point, and an encryption manner.

In a fourth aspect, an embodiment of the present application provides a user terminal, including:

an acquiring unit, configured to acquire a two-dimensional code; and

a processing unit, configured to parse the two-dimensional code to obtain information about the two-dimensional code, where the information about the two-dimensional code includes an access password of an access point and an identifier of the access point;

the processing unit is further configured to access the access point according to the access password of the access point and the identifier of the access point.

With reference to the fourth aspect, in a first possible implementation manner

the acquiring unit is specifically configured to acquire a two-dimensional code in a scanning manner.

With reference to the first possible implementation manner of the fourth aspect, in a second possible implementation manner, the acquiring unit is specifically configured to send a scanning request to the access point, so that the access point generates a two-dimensional code and displays the two-dimensional code on a screen, and is configured to scan the screen to acquire the two-dimensional code.

With reference to the fourth aspect, in a third possible implementation manner, the acquiring unit is specifically configured to acquire an image carrying a two-dimensional code, and is further configured to parse the image carrying the two-dimensional code to acquire the two-dimensional code.

With reference to the third possible implementation manner of the fourth aspect, in a fourth possible implementation manner, the acquiring unit is further configured to send a first request to the access point, so that the access point generates an image carrying a two-dimensional code, where the first request is configured to request an image carrying a two-dimensional code; and

the acquiring unit is further configured to receive first information sent by the access point, where the first information includes the image carrying the two-dimensional code.

With reference to the fourth possible implementation manner of the fourth aspect, in a fifth possible implementation manner, the acquiring unit is further configured to receive payment request information sent by the access point, so that a user, after making a payment according to the payment request information, receives first information sent by the access point, where the payment request information includes a pricing standard and a charging mode and the first information further includes information about duration or traffic in accessing the access point.

With reference to the second possible implementation manner of the fourth aspect, in a sixth possible implementation manner

the acquiring unit is further configured to scan the screen by using a camera.

With reference to the fourth aspect, the first possible implementation manner of the fourth aspect, or the second possible implementation manner of the fourth aspect, the information about the two-dimensional code further includes information about duration or traffic in accessing the access point.

In a fifth aspect, an embodiment of the present application provides an access point, including:

a receiving unit, configured to receive a scanning request sent by a user terminal;

a processing unit, configured to generate a two-dimensional code according to the scanning request received by the receiving unit; and

a display unit, configured to display the two-dimensional code on a screen, so that the user terminal scans the screen to acquire the two-dimensional code, parses the two-dimensional code to acquire information about the two-dimensional code, where the information about the two-dimensional code includes an access password of the access point and an identifier of the access point, and the user terminal accesses the access point according to the access password of the access point and the identifier of the access point.

With reference to the fifth aspect, in the first possible implementation manner, the processing unit is specifically configured to generate a two-dimensional code according to the identifier of the access point, the access password of the access point, and an encryption manner.

In a sixth aspect, an embodiment of the present application provides an access point, including:

a sending unit, configured to send an image carrying a two-dimensional code to a user terminal, so that the user terminal acquires the image carrying the two-dimensional code, the user terminal parses the image carrying the two-dimensional code to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point.

With reference to the sixth aspect, in a first possible implementation manner, the sending unit is specifically configured to receive a first request sent by the user terminal, where the first request is configured to request an image carrying a two-dimensional code, generate the image carrying the two-dimensional code according to the first request, and send first information to the user terminal, so that the user terminal acquires the first information, where the first information includes the image carrying the two-dimensional code.

With reference to the first possible implementation manner of the sixth aspect, in a second possible implementation manner, the sending unit is further configured to send payment request information to the user terminal, so that the user makes a payment according to the payment request information, where the payment request information includes a pricing standard and a charging mode and the first information further includes information about duration or traffic in accessing the access point.

With reference to the first possible implementation manner of the sixth aspect, in a third possible implementation manner, the sending unit is further configured to generate the two-dimensional code, and is configured to encapsulate the two-dimensional code into an image.

With reference to the third possible implementation manner of the sixth aspect, in a fourth possible implementation manner, the sending unit is further configured to generate the two-dimensional code according to the identifier of the access point, the access password of the access point, and an encryption manner.

According to the embodiments of the present application, a user terminal acquires a two-dimensional code, parses the two-dimensional code to acquire information about the two-dimensional code, where the information about the two-dimensional code includes an access password of an access point and an identifier of the access point, and the user terminal accesses the access point according to the access password of the access point and the identifier of the access point. A two-dimensional code is automatically scanned or acquired without a need to use a keyboard to enter a password or simultaneously click a WPS button, in which case the operation is convenient and simple and a size of a user terminal is reduced. In addition, occurrence of an error arising from entering a long password is avoided, thereby improving the efficiency in accessing an access point.

Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

### BRIEF DESCRIPTION OF DRAWINGS

To describe the technical solutions in the embodiments of the present application more clearly, the following briefly introduces the accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a flowchart of a method for accessing an access point according to an embodiment of the present application;

FIG. 2 is a flowchart of another method for accessing an access point according to an embodiment of the present application;

FIG. 3 is a flowchart of another method for accessing an access point according to an embodiment of the present application;

FIG. 4 is a structural diagram of a user terminal according to an embodiment of the present application;

FIG. 5 is a structural diagram of another user terminal according to an embodiment of the present application;

FIG. 6 is a structural diagram of an access point according to an embodiment of the present application;

FIG. 7 is a structural diagram of another access point according to an embodiment of the present application; and

FIG. 8 is a structural diagram of another access point according to an embodiment of the present application.

### DESCRIPTION OF EMBODIMENTS

The following clearly and describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present application without creative efforts shall fall within the protection scope of the present application.

The specific embodiments are described in detail as follows:

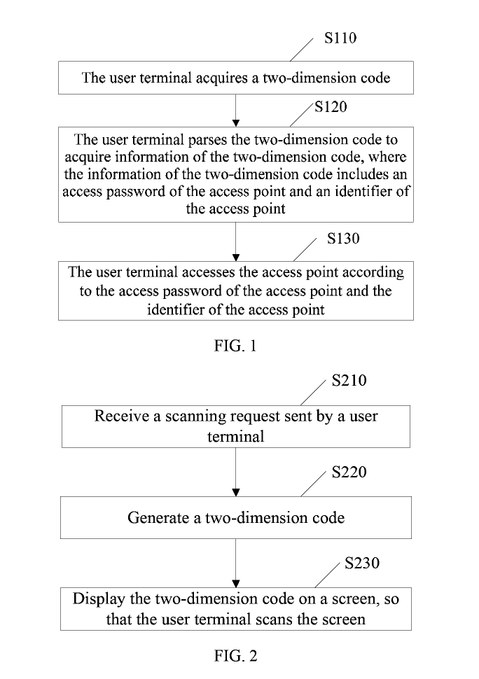

Referring to FIG. 1, FIG. 1 is a flowchart of a method for accessing an access point according to an embodiment of the present application. The method provided in this embodiment for accessing an access point is described based on that a user terminal is an executor; the user terminal is WiFi-enabled and may be a mobile phone, a computer, or a WiFi-enabled terminal without a keyboard. As shown in FIG. 1, the method provided in this embodiment for accessing an access point includes the following steps:

S110. The user terminal acquires a two-dimensional code.

In an embodiment, a user terminal may acquire a two-dimensional code in a scanning manner. Specifically, the steps may be as follows:

1. The user terminal sends a scanning request to an access point, so that the access point generates a two-dimensional code and displays the two-dimensional code on a screen; and

2. The user terminal scans the screen to acquire the two-dimensional code. Alternatively, the user terminal may use a camera to scan the screen to acquire the two-dimensional code.

Alternatively, after generating the two-dimensional code, the access point may print and output the two-dimensional code and provide a user a paper copy displaying the two-dimensional code, so that the user scans the paper copy by using the user terminal to acquire the two-dimensional code.

In an embodiment, a manner for acquiring a two-dimensional code by a user terminal specifically includes the following steps:

A. The user terminal acquires an image carrying a two-dimensional code; and

B. The user terminal parses the image carrying the two-dimensional code to acquire the two-dimensional code.

In an embodiment, a manner for acquiring an image carrying a two-dimensional code by a user terminal specifically includes the following steps:

a. The user terminal sends a first request to an access point, so that the access point generates an image carrying a two-dimensional code, where the first request is configured to request an image carrying a two-dimensional code; and

b. The user terminal receives first information sent by the access point, where the first information includes the image carrying the two-dimensional code.

Alternatively, after the user terminal sends a first request to the access point and before the user terminal receives the first information sent by the access point, the method further includes:

The user terminal receives payment request information sent by the access point, so that the user makes a payment according to the payment request information, where the payment request information includes a pricing standard and a charging mode and the first information further includes information about duration or traffic in accessing the access point.

S120. The user terminal parses the two-dimensional code to acquire information about the two-dimensional code, where the information about the two-dimensional code includes an access password of the access point and an identifier of the access point.

Alternatively, the information about the two-dimensional code further includes information about duration or traffic in accessing the access point. When the user has accessed the access point for an accumulated duration longer than the duration restricted in the information about the duration, or when the user, after accessing the access point, has used network traffic higher than the traffic restricted in the information about the traffic, the user automatically disconnects from the access point, or the network between the access point and the user terminal is disconnected by the access point.

S130. The user terminal accesses the access point according to the access password of the access point and the identifier of the access point.

According to the present application, a user terminal acquires a two-dimensional code, parses the two-dimensional code to acquire information about the two-dimensional code, and accesses an access point according to the information about the two-dimensional code, namely, an access password of the access point and an identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point.

Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

Referring to FIG. 2, FIG. 2 is a flowchart of another method for accessing an access point according to an embodiment of the present application. The method provided in this embodiment for accessing an access point is described based on that an access point is an executor; as shown in FIG. 2, the method provided in this embodiment for accessing an access point includes:

S210. Receive a scanning request sent by a user terminal.

S220. Generate a two-dimensional code.

S230. Display the two-dimensional code on a screen, so that the user terminal scans the screen to acquire the two-dimensional code, the user terminal parses the two-dimensional code to acquire information about the two-dimensional code, where the information about the two-dimensional code includes an access password of the access point and an identifier of the access point, and accesses the access point according to the access password of the access point and the identifier of the access point.

Alternatively, after generating the two-dimensional code, the access point may print and output the two-dimensional code and provide the user a paper copy displaying the two-dimensional code, so that the user scans the paper copy by using a user terminal to acquire the two-dimensional code.

Alternatively, the generating a two-dimensional code by the access point specifically includes the following step:

Generate a two-dimensional code according to the identifier of the access point, the access password of the access point, and an encryption manner.

According to this embodiment, an access point receives a scanning request sent by a user terminal, generates a two-dimensional code, and displays the two-dimensional code on a screen, so that the user terminal scans the screen to acquire the two-dimensional code, the user terminal parses the two-dimensional code to acquire information about the two-dimensional code, where the information about the two-dimensional code includes an access password of the access point and an identifier of the access point, and accesses the access point according to the access password of the access point and the identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point. Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

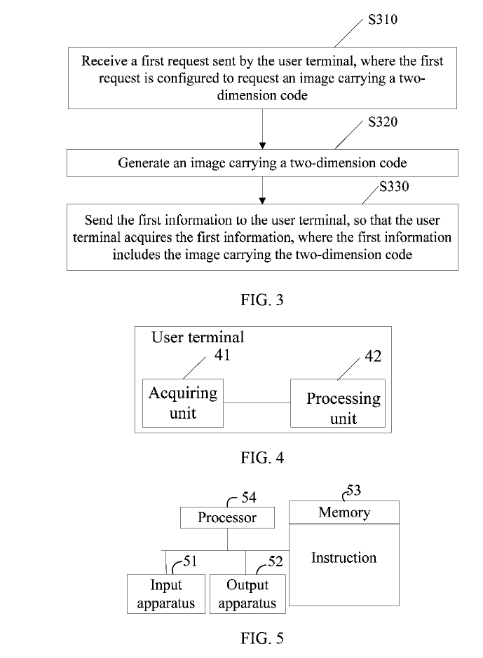

Referring to FIG. 3, FIG. 3 is a flowchart of another method for accessing an access point according to an embodiment of the present application. The method provided in this embodiment for accessing an access point is described based on that an access point is an executor. The method provided in this embodiment for accessing an access point includes:

Send an image carrying a two-dimensional code to a user terminal, so that the user terminal acquires the image carrying the two-dimensional code, the user terminal parses the image carrying the two-dimensional code to acquire the two-dimensional code, the user terminal parses the two-dimensional code to acquire information about the two-dimensional code, where the information about the two-dimensional code includes an access password of the access point and an identifier of the access point, and accesses the access point according to the access password of the access point and the identifier of the access point.

In an embodiment, as shown in FIG. 3, the sending an image carrying a two-dimensional code to a user terminal specifically includes the following steps:

S310. Receive a first request sent by the user terminal, where the first request is configured to request an image carrying a two-dimensional code.

S320. Generate an image carrying a two-dimensional code.

As an alternative implementation manner, after the receiving a first request sent by the user terminal and before sending first information to the user terminal, the method further includes:

Send payment request information to the user terminal, so that the user makes a payment according to the payment request information, where the payment request information includes a pricing standard and a charging mode and the first information further includes information about duration or traffic in accessing the access point.

S330. Send the first information to the user terminal, so that the user terminal acquires the first information, where the first information includes the image carrying the two-dimensional code.

In an embodiment, the generating an image carrying a two-dimensional code specifically includes the following steps:

Generate a two-dimensional code; and

Encapsulate the two-dimensional code into an image.

In an embodiment, the generating a two-dimensional code specifically includes the following step:

Generate a two-dimensional code according to an identifier of an access point, an access password of an access point, and an encryption manner.

According to this embodiment, an access point sends an image carrying a two-dimensional code to a user terminal, so that the user terminal acquires the image carrying the two-dimensional code, the user terminal parses the image carrying the two-dimensional code to acquire the two-dimensional code, the user terminal parses the two-dimensional code to acquire information about the two-dimensional code, where the information about the two-dimensional code includes an access password of the access point and an identifier of the access point, and accesses the access point according to the access password of the access point and the identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point. Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

Referring to FIG. 4, FIG. 4 is a structural diagram of a user terminal according to an embodiment of the present application. As shown in FIG. 4, the user terminal provided in this embodiment includes: an acquiring unit 41 and a processing unit 42.

The acquiring unit 41 is configured to acquire a two-dimensional code.

The processing unit 42 is configured to parse the two-dimensional code to obtain information about the two-dimensional code, where the information about the two-dimensional code includes an access password of an access point and an identifier of the access point.

The processing unit 42 is further configured to access the access point according to the access password of the access point and the identifier of the access point.

As an alternative implementation manner, the acquiring unit is specifically configured to acquire the two-dimensional code in a scanning manner.

As an alternative implementation manner, the acquiring unit is specifically configured to send a scanning request to the access point, so that the access point generates a two-dimensional code and displays the two-dimensional code on a screen, and is configured to scan the screen to acquire the two-dimensional code.

As an alternative implementation manner, the acquiring unit is specifically configured to acquire an image carrying a two-dimensional code, and is further configured to parse the image carrying the two-dimensional code to acquire the two-dimensional code.

As an alternative implementation manner, the acquiring unit is further configured to send a first request to the access point, so that the access point generates an image carrying a two-dimensional code, where the first request is configured to request an image carrying a two-dimensional code;

The acquiring unit is further configured to receive first information sent by the access point, where the first information includes an image carrying a two-dimensional code.

As an alternative implementation manner, the acquiring unit is further configured to receive payment request information sent by the access point, so that the user, after making a payment according to the payment request information, receives first information sent by the access point, where the payment request information includes a pricing standard and a charging mode and the first information further includes information about duration or traffic in accessing the access point.

As an alternative implementation manner, the acquiring unit is further configured to scan a screen by using a camera.

As an alternative implementation manner, the information about the two-dimensional code further includes information about duration or traffic in accessing the access point.

According to this embodiment, the acquiring unit 41 acquires a two-dimensional code and the processing unit 42 parses the two-dimensional code to acquire information about the two-dimensional code, where the information about the two-dimensional code includes an access password of an access point and an identifier of the access point. The processing unit 42 further accesses the access point according to the access password of the access point and the identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point. Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

Referring to FIG. 5, FIG. 5 is a structural diagram of another user terminal according to an embodiment of the present application. As shown in FIG. 5, the user terminal provided in this embodiment includes: an input apparatus 51, an output apparatus 52, a memory 53, and a processor 54, where the memory 53 stores a group of program code and the processor 54 calls the program code stored in the memory to perform the following operations:

Acquire a two-dimensional code;

Parse the two-dimensional code to acquire information about the two-dimensional code, where the information about the two-dimensional code includes an access password of an access point and an identifier of the access point; and

Access the access point according to the access password of the access point and the identifier of the access point.

According to the present application, the processor of the user terminal performs related operations, acquires a two-dimensional code, parses the two-dimensional code to acquire information about the two-dimensional code, where the information about the two-dimensional code includes an access password of an access point and an identifier of the access point, and accesses the access point according to the access password of the access point and the identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point.

Further, an encryption manner based on a two-dimensional code may be used to prevent a password from being stolen. In addition, a two-dimensional code may be generated by an access point, in which case a password leak does not occur easily and a system is prevented from breakdown caused by an attack by an unauthorized user.

As an alternative implementation manner, the acquiring a two-dimensional code by the processor may be specifically implemented by acquiring a two-dimensional code in a scanning manner.

As an alternative implementation manner, the acquiring a two-dimensional code by the processor in a scanning manner may be specifically implemented by performing the following operations:

Send a scanning request to the access point, so that the access point generates a two-dimensional code and displays the two-dimensional code on a screen; and

Scan the screen to acquire the two-dimensional code.

As an alternative implementation manner, the acquiring a two-dimensional code by the processor may be specifically implemented by performing the following operations:

Acquire an image carrying a two-dimensional code; and

Parse the image carrying the two-dimensional code to acquire the two-dimensional code.

As an alternative implementation manner, the acquiring an image carrying a two-dimensional code by the processor may be specifically implemented by performing the following operations:

Send a first request to the access point, so that the access point generates an image carrying a two-dimensional code, where the first request is configured to request an image carrying a two-dimensional code; and

Receive first information sent by the access point, where the first information includes the image carrying the two-dimensional code.

As an alternative implementation manner, after performing an operation of sending the first request to the access point and before performing an operation of receiving the first information sent by the access point, the processor is further configured to perform the following operation:

Receive payment request information sent by the access point, so that the user makes a payment according to the payment request information, where the payment request information includes a pricing standard and a charging mode and the first information further includes information about duration or traffic in accessing the access point.

As an alternative implementation manner, the scanning the screen by the processor is specifically implemented by performing the following operation:

Scan the screen by using a camera.

As an alternative implementation manner, the information about the two-dimensional code further includes information about duration or traffic in accessing the access point.

Referring to FIG. 6, FIG. 6 is a structural diagram of an access point according to an embodiment of the present application. As shown in FIG. 6, the access point provided in this embodiment includes: a receiving unit 61, a processing unit 62, and a display unit 63.

The receiving unit 61 is configured to receive a scanning request sent by a user terminal;

The processing unit 62 is configured to generate a two-dimensional code according to the scanning request received by the receiving unit 61; and

The display unit 63 displays the two-dimensional code on a screen, so that the user terminal scans the screen to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point.

As an alternative implementation manner, the processing unit is specifically configured to generate a two-dimensional code according to the identifier of the access point, the access password of the access point, and an encryption manner.

According to this embodiment, the receiving unit 61 receives a scanning request sent by the user terminal; the processing unit 62 generates a two-dimensional code according to the scanning request received by the receiving unit 61; the display unit 63 displays the two-dimensional code on a screen, so that the user terminal scans the screen to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point.

Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

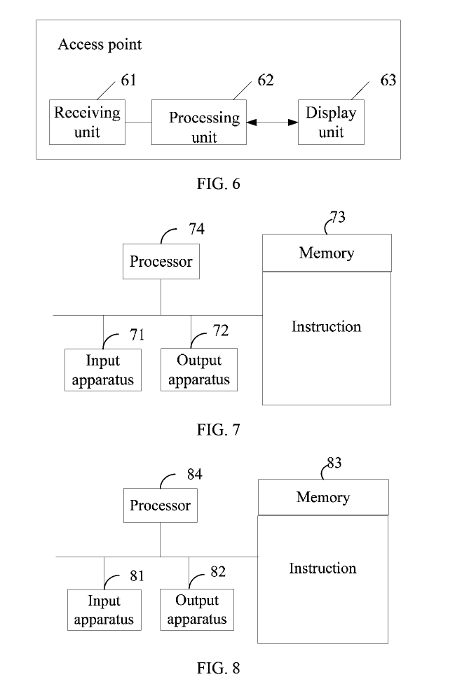

Referring to FIG. 7, FIG. 7 is a structural diagram of another access point according to an embodiment of the present application. As shown in FIG. 7, the access point provided in this embodiment includes: an input apparatus 71, an output apparatus 72, a memory 73, and a processor 74, where the memory 73 stores a group of program code and the processor 74 calls the program code stored in the memory to perform the following operations:

Receive a scanning request sent by a user terminal;

Generate a two-dimensional code; and

Display the two-dimensional code on a screen, so that the user terminal scans the screen to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point.

As an alternative implementation manner, the generating a two-dimensional code by the processor specifically includes the following step:

Generate a two-dimensional code according to the identifier of the access point, the access password of the access point, and an encryption manner.

According to this embodiment, the processor performs related operations to receive a scanning request sent by a user terminal, generate a two-dimensional code, and display the two-dimensional code on a screen, so that the user terminal scans the screen to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point.

Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

Another access point provided in this embodiment includes: a sending unit, configured to send an image carrying a two-dimensional code to a user terminal, so that the user terminal acquires the image carrying the two-dimensional code, the user terminal parses the image carrying the two-dimensional code to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point.

Alternatively, a sending unit is specifically configured to receive a first request sent by the user terminal, where the first request is configured to request an image carrying a two-dimensional code, and is configured to generate an image carrying a two-dimensional code according to the first request, and send first information to the user terminal, where the first information includes the image carrying the two-dimensional code, so that the user terminal acquires the first information.

In an embodiment, the sending unit is further configured to send payment request information to the user terminal, so that a user makes a payment according to the payment request information, where the payment request information includes a pricing standard and a charging mode and the first information further includes information about duration or traffic in accessing the access point.

In an embodiment, the sending unit is further configured to generate a two-dimensional code, and is configured to encapsulate the two-dimensional code into an image.

In an embodiment, the sending unit is further configured to generate a two-dimensional code according to the identifier of the access point, the access password of the access point, and an encryption manner.

Referring to FIG. 8, FIG. 8 is a structural diagram of another access point according to an embodiment of the present application. As shown in FIG. 8, the access point provided in this embodiment includes: an input apparatus 81, an output apparatus 82, a memory 83, and a processor 84, where the memory 83 stores a group of program code and the processor 84 calls the program code stored in the memory to perform the following operations:

Send an image carrying a two-dimensional code to a user terminal, so that the user terminal acquires the image carrying the two-dimensional code, the user terminal parses the image carrying the two-dimensional code to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point.

As an alternative implementation manner, the sending an image carrying a two-dimensional code to a user terminal by the processor specifically includes the following steps:

Receive a first request sent by the user terminal, where the first request is configured to request an image carrying a two-dimensional code;

Generate an image carrying a two-dimensional code; and

Send first information to the user terminal, where the first information includes the image carrying the two-dimensional code, so that the user terminal acquires the first information.

As an alternative implementation manner, after performing an operation of receiving a first request sent by a user terminal and before performing an operation of sending first information to the user terminal, the processor is further configured to perform the following operation:

Send payment request information to the user terminal, so that the user makes a payment according to the payment request information, where the payment request information includes a pricing standard and a charging mode and the first information further includes information about duration or traffic in accessing the access point.

As an alternative implementation manner, the generating an image carrying a two-dimensional code by the processor specifically includes the following steps:

Generate a two-dimensional code; and

Encapsulate the two-dimensional code into an image.

As an alternative implementation manner, the generating a two-dimensional code by the processor specifically includes the following step:

Generate a two-dimensional code according to the identifier of the access point, the access password of the access point, and an encryption manner.

According to this embodiment, a processor performs related operations to send an image carrying a two-dimensional code to a user terminal, so that the user terminal acquires the image carrying the two-dimensional code, the user terminal parses the image carrying the two-dimensional code to acquire the two-dimensional code, the user terminal parses the two-dimensional code to acquire information about the two-dimensional code, where the information about the two-dimensional code includes an access password of the access point and an identifier of the access point, and the user terminal accesses the access point according to the access password of the access point and the identifier of the access point. A two-dimensional code is automatically scanned or acquired without a need to use a keyboard to enter a password or synchronously click a WPS button, in which case the operation is convenient and simple and a size of a user terminal is reduced. In addition, occurrence of an error arising from entering a long password is avoided, thereby improving the efficiency in accessing an access point.

Further, an encryption manner based on a two-dimensional code is used to prevent a password from being stolen. In addition, a two-dimensional code may be generated by an access point, in which case a password leak does not occur easily and a system is prevented from breakdown caused by an attack by an unauthorized user.

In the several embodiments provided in the present application, it should be understood that the disclosed devices and methods may be implemented in other manners For example, the foregoing device embodiments are merely exemplary. For example, the division of the modules or units is merely logical function division and may be another division in actual implementation. For example, a plurality of units or modules may be combined or integrated into another system, or some features may be ignored or not performed. In addition, the displayed or discussed mutual couplings, direct couplings, or communication connections may be implemented through some interfaces. The indirect couplings or communication connections between the apparatuses, modules or units may be implemented in electronic, mechanical, or other forms.

The modules or units described as separate parts may or may not be physical separate, and the parts displayed as modules or units may or may not be physical modules or units, may be located in one position, or may be distributed on a plurality of network modules or units. Some or all of the modules or units may be selected to achieve the objectives of the solutions of the embodiments of the present invention according to actual needs.

In addition, functional modules or units in embodiments of the present invention may be integrated into one processing module or unit, or each of the modules or units may exist alone physically, or two or more modules or units may be integrated into one module or unit. The integrated module or unit may be implemented through hardware, or may also be implemented in a form of a software functional unit.

When the integrated module or unit is implemented in a form of a software functional module or unit and sold or used as an independent product, the integrated module or unit may be stored in a computer-readable storage medium. Based on such an understanding, the technical solutions of the present invention essentially, the part contributing to the prior art, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in the embodiments of the present invention. The foregoing storage medium includes: any mediums that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific embodiments of the present invention, but are not intended to limit the protection scope of the present invention. Any equivalent modification or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for accessing an access point, comprising:
acquiring, by a user terminal, a two-dimensional code;
parsing, by the user terminal, the two-dimensional code to obtain information about the two-dimensional code; and
accessing, by the user terminal, the access point according to a password of the access point and an identifier for the access point;
wherein the information about the two-dimensional code comprises the password of the access point and the identifier for the access point, and
wherein the user terminal comprises a processor.

2. The method for accessing an access point according to claim 1, wherein the acquiring, by a user terminal, a two-dimensional code comprises a method from the group consisting of:
acquiring, by the user terminal, the two-dimensional code in a scanning manner, and
acquiring, by the user terminal, an image carrying the two-dimensional code and parsing, by the user terminal, the image carrying the two-dimension code.

3. The method for accessing an access point according to claim 2, wherein the acquiring, by the user terminal, the two-dimensional code in a scanning manner comprises:
sending, by the user terminal, a scanning request to the access point, so that the access point generates the two-dimensional code and displays the two-dimension code on a screen; and
scanning, by the user terminal, the screen to acquire the two-dimension code.

4. The method for accessing an access point according to claim 2, wherein the acquiring, by the user terminal, an image carrying the two-dimensional code comprises:
sending, by the user terminal, a first request to the access point, wherein the first request is configured to request the access point generate an image carrying the two-dimensional code; and
receiving, by the user terminal from the access point, first information comprising the image carrying the two-dimensional code.

5. The method for accessing an access point according to claim 4, the method further comprising, after the sending the first request and before the receiving the first information:
receiving, by the user terminal, payment request information sent by the access point;
wherein the payment request information comprises a pricing standard and a charging mode, and
wherein the first information further comprises information about one of the group consisting of: duration in accessing the access point and traffic in accessing the access point.

6. The method for accessing an access point according to claim 3, wherein the information about the two-dimensional code further comprises one of the group consisting of: information about duration in accessing the access point and information about traffic in accessing the access point.

7. A method for providing a user terminal with access to an access point comprising a processor, comprising:
receiving, at the access point from a user terminal, a first request configured to request an image carrying a two-dimensional code;
generating an image carrying the two-dimensional code; and
sending, to the user terminal, first information comprising the image carrying the two-dimension code;
wherein sending, to the user terminal, the first information enables the user terminal to acquire the image carrying the two-dimension code, to parse the image carrying the two-dimensional code to acquire the two-dimensional code, and to acquire information about the two-dimension code, wherein the information about the two-dimension code comprises a password of the access point and an identifier of the access point, and to access the access point according to the password and the identifier.

8. The method for accessing an access point according to claim 7 further comprising after the receiving the first request and before sending the first information:
sending payment request information to the user terminal, wherein the payment request information comprises a pricing standard and a charging mode; and
wherein the first information further comprises one of the group consisting of: information about duration in accessing the access point and information about traffic in accessing the access point.

9. The method for accessing an access point according to claim 7, wherein the generating an image carrying the two-dimensional code comprises:
generating the two-dimensional code; and
encapsulating the two-dimensional code into an image.

10. The method for accessing an access point according to claim 9, wherein the generating the two-dimensional code comprises:
generating the two-dimensional code according to the identifier of the access point, the password of the access point, and an encryption manner.

11. A user terminal, comprising:
an acquiring unit, configured to acquire a two-dimensional code; and
a processor configured to parse the two-dimensional code to obtain information about the two-dimensional code, wherein the information about the two-dimension code comprises a password of an access point and an identifier of the access point, and the processor is further configured to access the access point according to the password and the identifier.

12. The user terminal according to claim 11, wherein:
the acquiring unit is configured to acquire the two-dimensional code in a scanning manner.

13. The user terminal according to claim 12, wherein the acquiring unit is configured to send a scanning request to an access point and to scan a screen to acquire the two-dimensional code.

14. The user terminal according to claim 11, wherein the acquiring unit is configured to acquire an image carrying a two-dimensional code and to parse the image carrying the two-dimensional code to acquire the two-dimensional code.

15. The user terminal according to claim 14, wherein the acquiring unit is further configured to send, to the access point, a first request to generate an image carrying the two-dimensional code and to receive first information sent by the access point, wherein the first information comprises the image carrying the two-dimensional code.

16. The user terminal according to claim 15, wherein the acquiring unit is further configured to receive payment request information sent by the access point, wherein the payment request information comprises a pricing standard and a charging mode, and
wherein the first information further comprises one of the group consisting of: information about duration in accessing the access point and information about traffic in accessing the access point.

17. The user terminal according to claim 13, wherein:
the acquiring unit is further configured to scan the screen by using a camera.

18. The user terminal according to claim 13, wherein the information about the two-dimensional code further comprises one of the group consisting of: information about duration in accessing the access point and information about traffic in accessing the access point.
